(19) United States
(12) Patent Application Publication
(10) Pub. No.: US 2012/0038663 A1
(43) Pub. Date: Feb. 16, 2012

(54) Composition of a Digital Image for Display on a Transparent Screen

(76) Inventors: Harald Gustafsson, Lund (SE); Jan Patrik Persson, Lund (SE); Per Persson, Sodra Sandby (SE); Song Yuan, Lund (SE)

(21) Appl. No.: 12/855,063

(22) Filed: Aug. 12, 2010

(51) Int. Cl. G09G 5/00

(52) U.S. Cl. 345/629

(57) ABSTRACT

Teachings herein prepare a digital image for display on a substantially transparent screen. The teachings advantageously recognize that the perceptibility of the digital image on the screen will often depend on what is visible to a user through the screen, since that will effectively serve as the background of the screen. A method of preparing a digital image thus includes dynamically calculating which part of an environmental background is visible to a user through the screen and thereby serves as an effective background of the screen. This calculation may entail obtaining an image of the environmental background and identifying which part of that image serves as the effective background (e.g., based on the angle at which the user views the screen). The method further includes composing the digital image for perceptibility as viewed against that effective background and outputting the composed image as digital data for display on the screen.

### TECHNICAL FIELD

The present invention relates generally to digital image composition, and particularly to composing a digital image to provide for the perceptibility of the image as viewed on a substantially transparent screen.

### BACKGROUND

Advances in display technology have greatly enhanced the accessibility of digital information. Heads-up displays (HUDs), for example, are becoming more prominent display accessories for military and commercial aviation, automobiles, gaming, and the like. HUDs display a digital image on a transparent screen placed in front of a user. From the perspective of the user, then, HUDs superimpose the digital image onto whatever is behind the screen. This allows the user to more quickly, more easily, and more safely view the image without looking away from his or her desired viewpoint. For instance, with such technology a driver of an automobile can view navigational instructions or speed information without taking his or her eyes off the road, a fighter pilot can view target information or weapon status information without taking his or her eyes off of the target, and so on. And although for perhaps less practical advantages than these, some computer laptops, mobile communication devices, and other such mobile devices are now equipped with transparent screens as well.

The ability of a transparent screen to conveniently superimpose a digital image onto whatever is behind the screen is thus an advantage of such a screen. However, that advantage also creates a practical challenge. Indeed, depending on exactly what is behind the screen, all or part of the digital image may sometimes be difficult for a user to perceive. Consider, for example, a digital image that includes green text. If a patch of green trees is behind the transparent screen, the green text will be much more difficult for the user to perceive than if instead a patch of purple flowers had been behind the screen.

Of course in many cases a user cannot practically change the position or orientation of the transparent screen so that whatever is behind the screen provides better perceptibility of a digital image. In the case of an automobile heads-up display, for instance, such would require changing the direction of the entire automobile. Moreover, even in those cases where it may indeed be practical, there may not be anything in the vicinity of the user that would provide better perceptibility (e.g., there may not be a patch of purple flowers around).

### SUMMARY

Teachings herein prepare a digital image for display on a substantially transparent screen. The teachings advantageously recognize that the perceptibility of the digital image on the screen will often depend on what is visible to a user through the screen, since that will effectively serve as the background of the screen. In a general sense, then, the methods and apparatus determine the effective background of the transparent screen and then compose the digital image so that the image will be perceptible against that background.

More particularly, in various embodiments discussed below, a method of preparing a digital image includes receiving environmental background data relating to an environmental background which is visible, at least in part, to a user through the screen. The method further includes dynamically calculating, based on that environmental background data, which part of the environmental background is visible to the user through the screen and thereby serves as an effective background of the screen. For example, in some embodiments the environmental background data comprises an image of the environmental background, such that dynamic calculation entails identifying which part of that image serves as the effective background of the screen. Having calculated the effective background of the screen, the method next includes composing the digital image for perceptibility as viewed against that effective background and outputting the composed digital image as digital data for display on the screen.

In composing the digital image for perceptibility, some embodiments recognize the digital image as consisting of one or more logical objects (e.g., buttons of a user interface) that may be spatially arranged and/or colored in different possible ways without substantially affecting the meaning conveyed by the image. Exploiting this property, these embodiments compose the digital image from one or more logical objects that have a spatial arrangement or coloration determined in dependence on evaluation of the effective background. For example, the embodiments may selects certain colors for different logical objects in the digital image and/or arrange those objects within the image so that they are perceptible as viewed against the effective background.

An image processor configured to prepare a digital image as described above includes a communications interface, an effective background calculator, and an image composer. The communications interface is configured to receive the environmental background data, while the effective background calculator is configured to dynamically calculate the effective background based on that environmental background data. The image composer is then configured to compose the digital image for perceptibility as viewed against that effective background and to output the digital image for display on the screen.

The image processor may be communicatively coupled to a memory, one or more detectors, and the transparent screen. The one or more detectors are configured to assist the image processor with this dynamic calculation and composition, by providing the image processor with the environmental background data. In some embodiments, for example, the one or more detectors include a rear camera mounted on or near the screen that directly captures an image of the environmental background and provides that rear image to the image processor. Having obtained this rear image from the detector(s), the image processor may then dynamically calculate which part of the rear image serves as the effective background of the screen.

In embodiments where the screen remains fixed relative to the user, the image processor may calculate this part of the rear image as simply a fixed or pre-determined part of the rear image (e.g., by implementing a pre-determined cropping of the rear image). In other embodiments, though, such as where a user may view the screen at any number of different angles, the image processor may calculate the part of the rear image that serves as the effective background based on the user's actual viewing angle. In particular, the one or more detectors mentioned above may further include a front camera that captures an image of the user and provides that front image to the image processor. The image processor then calculates the user's viewing angle by detecting the location of the user's face or eyes in the front image (or a processed version thereof). The image processor may then dynamically calculate which part of the rear image serves as the effective background of the screen based on the viewing angle determined from the front image.

Of course, the present invention is not limited by the above features and advantages. Those of ordinary skill in the art will appreciate additional features and advantages upon reading the following detailed description of example embodiments, and reviewing the figures included therein.

### BRIEF DESCRIPTION OF THE DRAWINGS

FIG. 1 is a block diagram of an image processor configured to prepare a digital image for display on a substantially transparent screen, according to some embodiments of the present invention.

FIGS. 2 illustrates a device communicatively coupled to a transparent screen that moves with the orientation of the user's head so as to remain fixed relative to the user, according to some embodiments of the present invention.

FIGS. 3A-3H illustrate an example of digital image preparation according to various embodiments of the present invention where the substantially transparent screen remains fixed relative to the user

FIGS. 4A-4B illustrates a device communicatively coupled to a transparent screen that remains fixed relative to the user, according to other embodiments of the present invention.

FIG. 5 illustrates a device with a transparent screen that may be viewed by a user at any number of different angles, according to some embodiments of the present invention.

FIGS. 6A-6G illustrate an example of digital image preparation according to other embodiments of the present invention where the substantially transparent screen may be viewed by a user at any number of different angles.

FIG. 7 is a logical flow diagram illustrating a method of preparing a digital image for display on a substantially transparent screen, according to some embodiments of the present invention.

### DETAILED DESCRIPTION

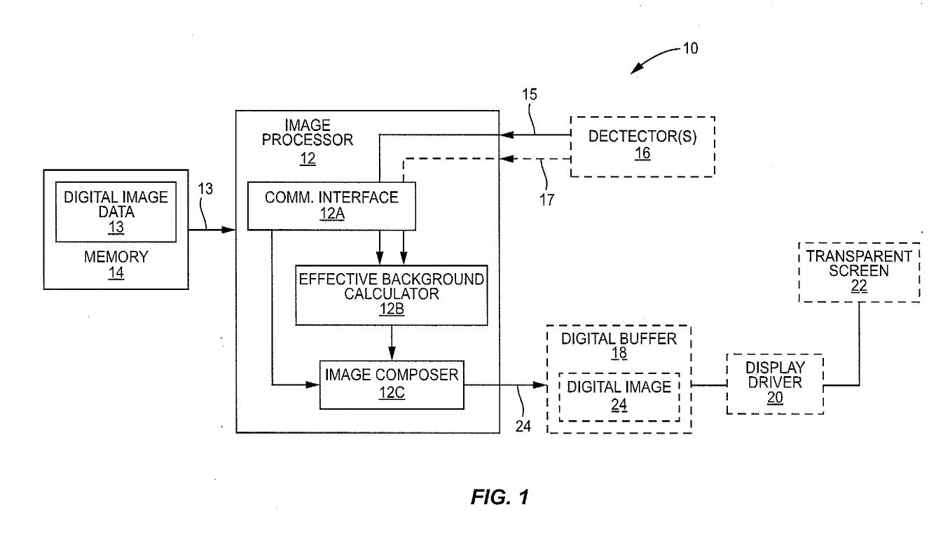

FIG. 1 depicts a device 10 according to various embodiments of the present invention. The device 10 as shown includes an image processor 12 and a memory 14, and further includes or is communicatively coupled to one or more detectors 16, a display buffer 18, a display driver 20, and a transparent screen 22.

The transparent screen 22 in some embodiments is integrated into the device 10 as a dedicated display for the device 10. In other embodiments, the transparent screen 22 is external to the device 10, but may be communicatively coupled to the device 10 as a display accessory. In either case, whatever the screen 22 is physically disposed in front of is generally referred to herein as the environmental background. In one sense, then, the environmental background includes the various objects, surfaces, and the like that collectively form the general scenery behind the screen 22.

As the screen 22 is substantially transparent, at least part of this environmental background will be visible to a user of the device 10 through the screen 22. Which particular part of the environmental background will be visible may in some cases depend on several factors, such as the dimensions of the screen 22, the position and orientation of the screen 22 relative to the user, and so on. Whatever part is visible, though, will effectively serve as the background of the screen 22 and will thus have an effect on the perceptibility of any image displayed on the screen 22.

In this regard, the image processor 12 is advantageously configured to prepare a digital image 24 for display on the transparent screen 22. As shown, the image processor 12 includes a communications interface 12A configured to receive environmental background data 15 relating to the environmental background. The image processor 12 further includes an effective background calculator 12B configured to dynamically calculate, based on the environmental background data 15, which part of the environmental background is visible to the user through the screen 22 and thereby serves as the effective background of the screen 22. An image composer 12C also included in the image processor 12 is then configured to compose the digital image 24 for perceptibility as viewed against that effective background (e.g., in accordance with digital image data 13 stored in memory 14). Such composition may entail selecting certain colors for different logical objects in the digital image 24 and/or arranging those objects within the image 24 so that they are perceptible as viewed against the effective background. These and other approaches to composition of the digital image 24 are discussed in more detail below.

With the image 24 composed for perceptibility, the image composer 12C is configured to output the composed image 24 as digital data for display on the screen 22. In particular reference to FIG. 1, for example, the image composer12C is configured to output the composed image 24 to the display buffer 18. The display driver 20 is configured to then retrieve the image 24 from the display buffer 18 and display it on the transparent screen 22.

The one or more detectors 16 are configured to assist the image processor 12 with this dynamic calculation and composition, by directly or indirectly providing the image processor 12 with environmental background data 15. In some embodiments, for example, the one or more detectors 16 include a rear camera mounted on or near the screen 22 that captures an image of the environmental background and provides that rear image to the image processor 12. Having received this rear image from the detector(s) 16, the image processor 12 may then dynamically calculate which part of the rear image serves as the effective background of the screen 22.

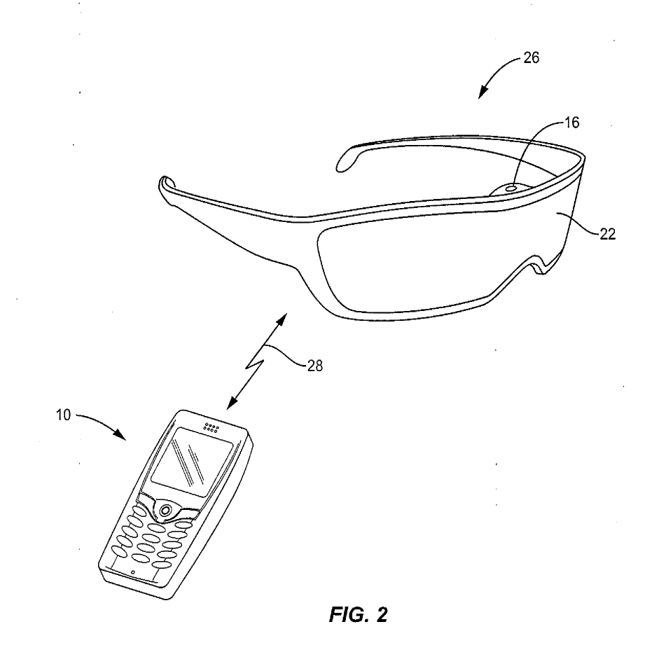

Consider, for example, FIG. 2, which illustrates embodiments where the device 10 is a mobile device communicatively coupled (e.g., via a wireless connection 28) to a heads-up display (HUD) system 26. The HUD system 26 includes a transparent screen 22 and a rear camera 16 center-mounted just above the screen 22, both of which move with the orientation of the user's head so as to remain fixed relative to the user. The rear camera 16 dynamically captures an image of the environmental background and provides this rear image (e.g., over the wireless connection 28) to the image processor 12 included in the device 10. The image processor 12 then calculates which part of the rear image serves as the effective background of the screen 22, composes a digital image 24 for perceptibility, and then outputs the composed image 24 for display on the screen 22.

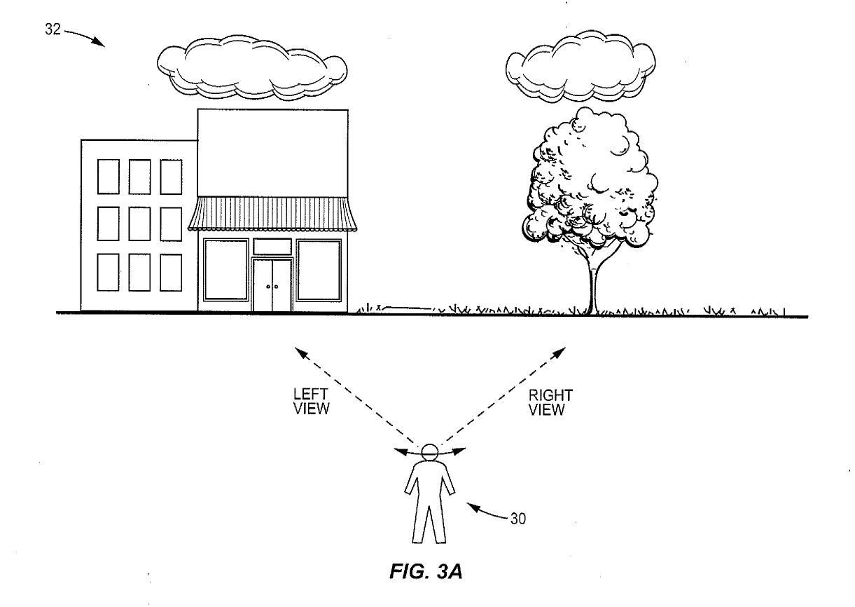

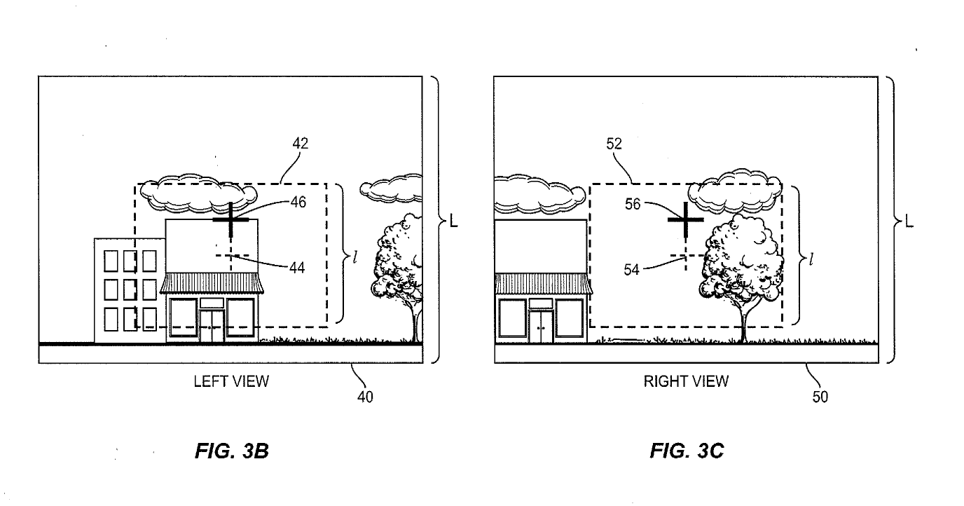

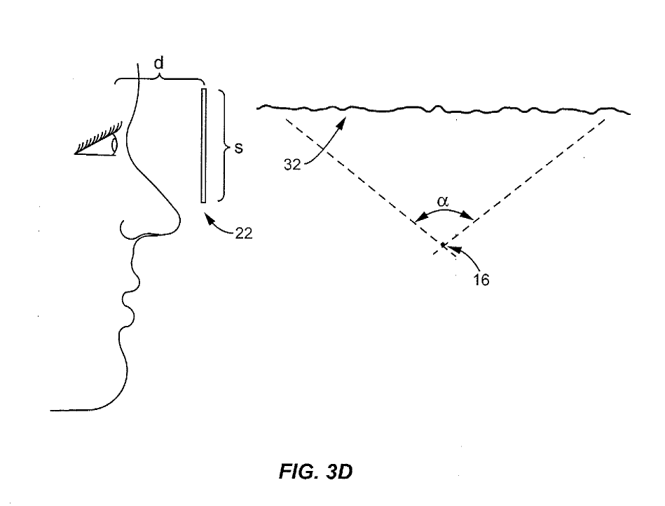

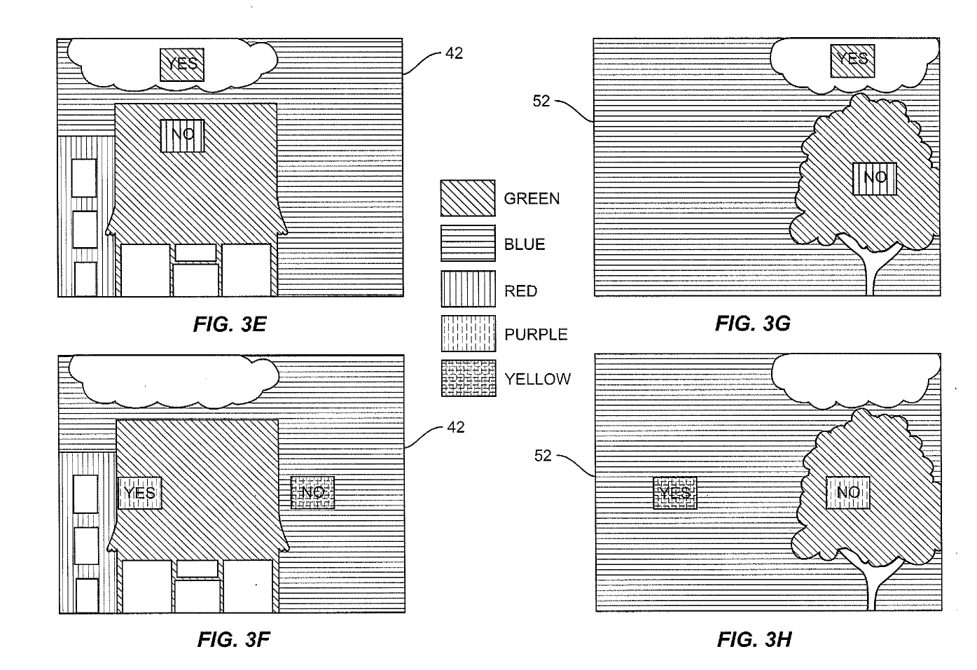

FIGS. 3A-3H provide an example of these embodiments, whereby a user 30 wears the HUD system 26 in FIG. 2. In FIG. 3A, an example environmental background 32 includes various buildings, the sky, the ground, and a tree. Which part of this environmental background 32 is visible to the user 30 through the screen 22 of the HUD system 26 depends on the geographic position of the user 30 and/or the direction in which the user 30 rotates his or her head. As positioned in FIG. 3A, for example, if the user 30 rotates his or her head more to the left, primarily the buildings will be visible through the screen 22; likewise, if the user 30 rotates his or her head more to the right, primarily the tree will be visible.

With the rear camera 16 mounted to the HUD system 26 and rotating left and right with the orientation of the user's head, the camera 16 dynamically captures a rear image of the environmental background 32. FIGS. 3B and 3C show example rear images 40 and 50 of the environmental background 32, as dynamically captured by the rear camera 16 in these two situations.

In FIG. 3B, the user 30 rotated his or her head more to the left and the rear camera 16 thereby captured rear image 40 and provided that image 40 to the image processor 12. Having obtained this image 40, the image processor 12 dynamically calculates which part of the rear image 40 serves as the effective background of the screen 22. In the example of FIG. 3B, the image processor 12 calculates this part to be the area 42 around point 44 in the rear image 40, based on the dimensions of the screen 22, the dimensions of the rear image 40, the field of view of the rear camera 16, and the distance between the user and the screen 22.

In more detail, the image processor 12 may first determine point 44 as the calibrated center point 44 of the rear image 40. That is, in embodiments where the rear camera 16 is physically offset from the geometric center of the screen 22, the actual center point 46 of the rear image 40 does not correspond to the central point of the user's viewpoint through the screen 22. In FIG. 2, for example, the rear camera 16 is mounted above the screen 22, so the central point of the user's viewpoint through the screen 22 will in fact be below the actual center point 46 of the rear image 40. The image processor 12 thus calibrates the actual center point 46 by displacing it vertically downward to compensate for the offset of the rear camera 16 from the center of the screen 22. The resulting calibrated center point 44 may then be used by the image processor 12 as the point around which area 42 is calculated.

As suggested above, the image processor 12 calculates the particular dimensions of area 42 based on the dimensions of the screen 22, the dimensions of the rear image 40, the field of view of the rear camera 16, and the distance between the user and the screen 22. In particular, the image processor 12 calculates the length I along one side of area 42 (e.g., in pixels) according to the following:

$$l = s \cdot ( 1 + \frac{L \cdot cot ( \frac{α}{2} )}{2 \cdot d} )$$

where s is the length along a corresponding side of the screen 22, L is the length along a corresponding side of the rear image 40 (e.g., in pixels), α is the field of view of the rear camera 16, and d is the distance between the user 30 and the screen 22 (which may be pre-determined according to the typical distance between a user and the particular type of screen 22). FIGS. 3B and 3D graphically illustrates these values as well. The image processor 12 thus calculates area 42 by calculating the length 1 along each side of area 42 in a similar manner.

Of course, many or all of these values may in fact be fixed for a given device 10 and/or HUD system 26. The rear camera 16, for example, may remain fixed at a given distance above the center of the screen 22. Likewise, the dimensions of the screen 22 may be fixed, as may the dimensions of the rear image 40, the field of view of the rear camera 16, and the distance between the screen 22 and the user 30. Moreover, the user's head and eyes remain fixed relative to the screen 22, as the HUD system 26 remains fixed to the user 30. Accordingly, the image processor 12 in some embodiments is configured to derive the area 42 as simply a fixed or pre-determined part of the rear image 40 (e.g., by implementing a pre-determined cropping of the rear image 40).

Notice in FIG. 3C, for instance, that the image processor 12 calculates the same relative area 52 in a rear image 50 captured by the rear camera 16 as the user 30 rotated his or her head to the right. That is, the calibrated center point 54 in rear image 50 corresponds precisely to the calibrated center point 44 in rear image 40, as the rear camera 16 remains fixed at a given distance above the center of the screen 22 between when the user rotated his or head left and right. Similarly, the length l along each side of area 52 in rear image 50 corresponds precisely to the length l along each side of area 42 in rear image 40, as the dimensions of the screen 22, the dimensions of the rear image, the field of view of the rear camera 16, and the distance between the screen 22 and the user 30 remain fixed.

Returning back to the example of FIG. 3B, though, once the image processor 12 calculates area 42 as being the part of the rear image 40 that serves as the effective background of the screen 22, the processor 12 composes the digital image 24 for perceptibility as viewed against area 42. To compose the image 24 for perceptibility, the image processor 12 in some embodiments recognizes the digital image 24 as consisting of one or more logical objects. A logical object as used herein comprises a collection of logically related pixel values or geometrical primitives, such as the pixel values or geometrical primitives that make up a button of a user interface. Often, logical objects may be spatially arranged within the image 24 and/or colored in different possible ways without substantially affecting the meaning conveyed by the image 24. Exploiting this property of logical objects, the image processor 12 composes the digital image 24 from one or more logical objects that have a spatial arrangement or coloration determined in dependence on evaluation of area 42 as the effective background. Consider, for example, FIGS. 3E and 3F.

In FIG. 3E, the image processor 12 composes the digital image 24 from various logical objects, including a green YES button and a red NO button, that have a spatial arrangement determined in dependence on evaluation of area 42. The green YES button is spatially arranged within the image 24 so that it is displayed against the white cloud in area 42, while the red NO button is spatially arranged within the image 24 so that it is displayed against the green building. By spatially arranging the buttons in this manner, the meaning of the digital image 24 remains substantially the same as if the buttons had been arranged in some other manner; indeed, it does not substantially matter where on the screen 22 the buttons are displayed to a user. Yet because the YES button is displayed against the white cloud rather than against the green building or blue sky, the perceptibility of the YES button is enhanced, since the green color of the YES button contrasts better with the white color of the cloud than the green color of the building or the blue color of the sky. The button's perceptibility is also enhanced because it is displayed against only a single color, white, rather than multiple different colors (e.g., red and white). The same can be said for the NO button.

To compose the digital image 24 in this way, the image processor 12 may conceptually “subdivide” the effective background (e.g., area 42) into different regions and then determine, for each region, the extent to which the region contrasts with one or more different colors, and/or the color variance in the region. Such relationships between different colors, i.e., whether or not a certain color contrasts well with another color, may be stored as a look-up table in memory 14 or computed by the image processor 12 on the fly. The image processor 12 may then place logical objects within the digital image 24 based on this determination, so that any given logical object will be displayed against a region of effective background which has higher contrast with one or more colors of the logical object than another region and/or lower color variance than another region.

Of course, the image processor 12 may quantify these values for determining the particular placement of a logical object like the green YES button. The image processor 12 may, for instance, quantify the extent to which regions of the effective background contrast with one or more colors in terms of contrast metrics, and compare the contrast metrics to determine the region which has the highest contrast with those color(s). Similarly, the image processor 12 may quantify the color variance in the regions of the effective background as a variance metric, and compare the variance metrics to determine the region which has the lowest color variance. Finally, the image processor 12 may quantify the extent to which a region contrasts with one or more colors and the color variance in that region as a joint metric. Such a joint metric may be based upon, for example, a weighted combination of one or more contrast metrics for the region and a variance metric for the region. The image processor 12 may then compare the joint metrics to determine the region that offers the best perceptibility as indicated by the joint metric for that region.

The image processor 12 may also take other considerations into account when placing a logical object like the green YES button, such as the placement of other logical objects, e.g., the red NO button. In this regard, the image processor 12 may be configured to jointly place multiple logical objects within the digital image 24, to provide for perceptibility of the image 24 as a whole rather than for any one logical object.

In other embodiments, the image processor 12 may not place logical objects within the digital image 24 based on evaluation of the effective background. Rather, in these embodiments, the logical objects' placement is set in some other way, and the image processor 12 instead selects color(s) for the objects based on evaluation of the effective background. Thus, for any given logical object otherwise placed, the image processor 12 selects one or more colors for the object that have higher contrast with a region of the effective background against which the logical object will be displayed than other possible colors.

In FIG. 3F, for example, the image processor 12 composes the digital image 24 from various logical objects that have a coloration determined in dependence on evaluation of area 42. With the image 24 composed in this way, the YES button has a purple coloration and the NO button has a yellow coloration. By coloring the buttons in this manner, the meaning of the digital image 24 remains substantially the same as if the buttons had been colored in a different way; indeed, it does not substantially matter whether the buttons are displayed to a user as green and red buttons or as purple and yellow buttons. Yet because the buttons are displayed as purple and yellow buttons, which have a higher contrast with the green building and blue sky against which the buttons are displayed, the perceptibility of the buttons is enhanced as compared to if they instead were displayed as green and red buttons.

FIGS. 3G and 3H similarly illustrate different ways the image processor 12 may compose the digital image 24 for perceptibility as viewed against area 52 in FIG. 3C; that is, when the user 30 rotates his or head to the right rather than to the left. In FIG. 3G, the image processor 12 spatially arranges the green YES button and the red NO button differently than in FIG. 3E, since the effective background (i.e., area 52) when the user rotates his or her head to the right is different than the effective background (i.e., area 42) when the user rotates his or her head to the left. Likewise, in FIG. 3H, the image processor 12 colors the buttons differently than in FIG. 3F. As shown by these examples, then, the image processor 12 composes the digital image 24 based on the particular effective background of the screen 22, so that the image 24 is perceptible as viewed against that effective background.

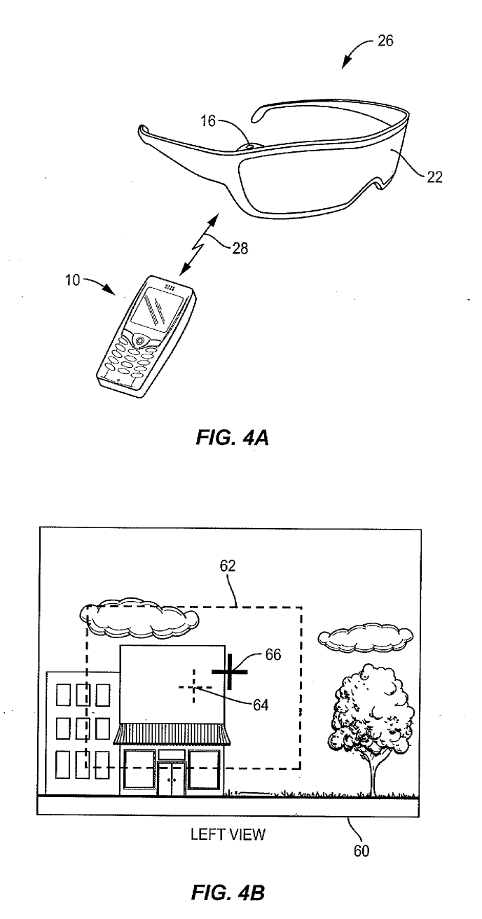

Those skilled in the art will of course appreciate that FIGS. 3A-3H merely illustrate non-limiting examples and that other variations and/or modifications to the device 10 may be made without departing from the scope of the present invention. FIGS. 4A-4B, for instance, illustrate one variation where the rear camera 16 included in the HUD system 26 is physically offset both vertically and horizontally from the center of the screen 22, rather than just vertically as in FIG. 2. In such a case, the image processor 12 may calibrate the center point of the rear image by displacing it vertically and horizontally to compensate for this offset.

For example, in FIG. 4A the rear camera 16 is still mounted above the screen 22, but instead of being mounted in horizontal alignment with the center of the screen 22 as in FIG. 2, it is mounted on the right side of the screen 22 (from the user's perspective). The rear image 60 captured by this rear camera 16 (in FIG. 4B) will therefore be slightly offset to the right as compared to the rear image 40 (in FIG. 3B) captured by the horizontally aligned rear camera. Accordingly, the central point of the user's viewpoint through the screen 22 will not only be below the actual center point 66 of the rear image 60, but it will also be to the left of that point 66. The image processor 12 in such a case is therefore configured to calibrate the center point 66 by displaying it vertically downward and horizontally to the left to compensate for the offset of the rear camera 16. The resulting calibrated center point 64 may then be used by the image processor 12 as the point around which area 62 is calculated.

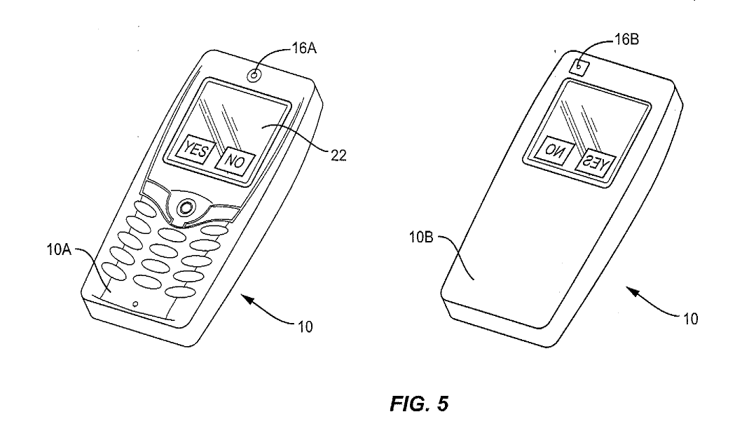

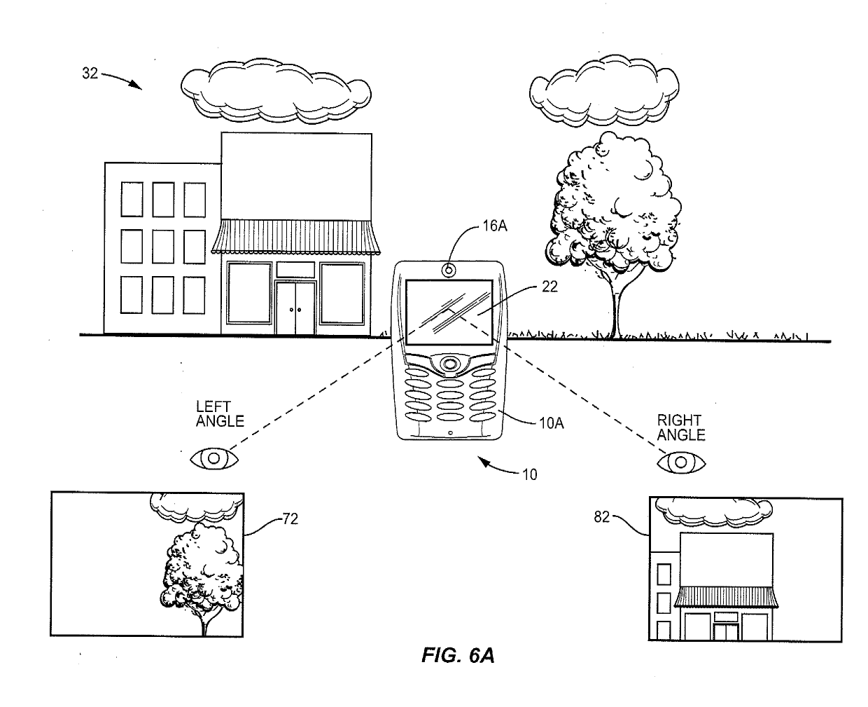

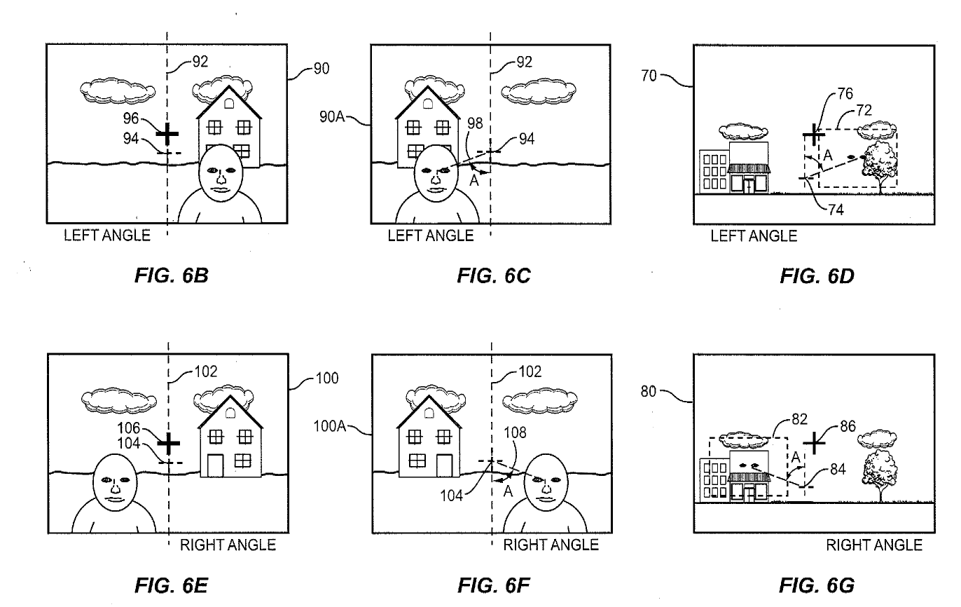

FIGS. 5 and 6A-6G illustrate still other embodiments. In these embodiments, the transparent screen 22 does not move with the orientation of a user's head so as to remain fixed relative to the user, as in FIGS. 2, 3A-3H, and 4A-4B. With the screen 22 not remaining fixed relative to the user, he or she may view the screen 22 from any number of different angles. The effective background of the screen 22, therefore, varies based on the user's viewing angle. The image processor 12 in these embodiments is advantageously configured to receive viewing angle data 17 relating to the viewing angle at which the user views the screen 22, to determine the viewing angle based on that viewing angle data 17, and to dynamically calculate the effective background of the screen 22 based on that viewing angle.

FIG. 5 shows one example of a device 10 where the screen 22 does not move with the orientation of the user's head. In FIG. 5, the device 10 is a handheld mobile device that itself includes the transparent screen 22. A user of the device 10 may view the screen 22 by holding the device 10 at any number of different angles from him or her. To assist the image processor 12 included in the device 10 determine the viewing angle at which the user views the screen 22, the device 10 includes a front camera 16A on a front face 10A of the device 10. The front camera 16A is configured to capture a front image that includes the user and to provide that image to the image processor 12. Having received this front image as viewing angle data 17, the image processor 12 detects the location of the user's face or eyes in the front image (or some processed version of that image) and calculates the viewing angle based on that location.

The device 10 also includes a rear camera 16B on a rear face 10B of the device 10, for capturing a rear image of the environmental background much in the same way as discussed above. Having also received this rear image as environmental background data 15, the image processor 12 dynamically calculates which part of the rear image serves as the effective background of the screen 22 based on the viewing angle determined from the front image.

FIGS. 6A-6G illustrate additional details of such calculation in the context of a helpful example. In FIG. 6A, which part of the environmental background 32 is visible to the user through the screen 22 of the device 10 and therefore serves as the effective background of the screen 22 depends on the user's viewing angle. If the user views the screen 22 at the left angle illustrated in the figure, for example by holding the device 10 more to his or her right side, the effective background of the screen 22 will primarily include the tree (e.g., as in area 72); likewise, if viewed at the right angle illustrated by holding the device 10 more to his or her left side, the effective background of the screen 22 will primarily include the buildings (e.g., as in area 82).

To assist the image processor 12 determine the viewing angle, the front camera 16A is configured to capture a front image that includes the user. FIG. 6B shows an example of a front image 90 captured by the front camera 16A when the user views the screen 22 at the left angle illustrated in FIG. 6A. As the front image is of course taken from the perspective of the front camera 16A, the user appears on the right side of that image 90.

In some embodiments, the image processor 12 is configured to determine the viewing angle from this front image 90 by first calibrating the center point 96 of the image 90. That is, as the front camera 16A of the device 10 is mounted above the center of the screen 22, the image processor 12 calibrates the actual center point 96 of the front image 90 by displacing it vertically downward to compensate for that offset. The image processor 12 may then digitally flip the front image 90 about a vertical axis 92 extending from the resulting calibrated center point 94, to obtain a horizontally flipped (i.e., horizontally mirrored) version of the front image 90A as shown in FIG. 6C. After flipping the image 90 in this way, the image processor 12 may then detect the location of the user's face or eyes in the flipped version of the front image 90A (e.g., using known face or eye detection techniques) and calculates the viewing angle A as the angle between the vertical axis 92 and the line 98 extending between the calibrated center point 94 and that location.

Notice that because the front camera 16A was horizontally centered above the center of the screen 22 in this example, the image processor 12 need not have calibrated the center point 96 of the front image 90 before horizontally flipping the image 90 about the vertical axis 92. Indeed, the vertical axis 92 remained the same both before and after calibration. In embodiments where the front camera 16A is not horizontally centered, though, the vertical axis 92 would shift with the displacement of the center point 96, meaning that calibration should be done prior to horizontal flipping.

Of course, in other embodiments, the image processor 12 calculates the viewing angle A without digitally flipping the front image 90, which involves somewhat intensive image processing. In these embodiments, the image processor 12 instead calculates the viewing angle A directly from the front image 90 (i.e., the un-flipped version shown in FIG. 6B). Specifically, the image processor 12 detects the location of the user's face or eyes in the front image 90 shown in FIG. 6B and calculates an angle Â between the vertical axis 92 and a line (not shown) extending between the calibrated center point 94 and that location. The image processor 12 then adjusts the calculated angle A as needed to derive the viewing angle A that would have been calculated had the front image 90 been flipped as described above.

In any event, FIG. 6D illustrates the image processor's use of the viewing angle A determined from the front image (90 or 90A) to calculate which part of a rear image 70 captured by the rear camera 16B serves as the effective background of the screen 22. In particular, the image processor 12 obtains the rear image 70 of the environmental background 32 from the rear camera 16B. As the rear camera 16B is mounted above the screen 22, on the right side (from the user's perspective), the image processor 12 calibrates the actual center point 76 of the rear image 70 by displacing it vertically downward and horizontally to the left to compensate for that offset. The processor 12 then uses the resulting calibrated center point 74 rather than the actual center point 76 to determine the effective background.

Specifically, the processor 12 determines the location in the rear image 70 that would correspond to the location of the user's face or eyes in the flipped version of the front image 90A, as transposed across the calibrated center point 74 at the viewing angle A. This may entail, for example, determining the location as the point that is offset from the effective center point 74 of the rear image 70 by the same amount and at the vertically opposite angle A as the user's face or eyes is from the effective center point 94 of the flipped version of the front image 90A. FIG. 6D shows this location in the rear image 70 as a pair of eyes.

Having determined this location in the rear image 70, the image processor 12 then derives the area 72 around that location as being the part of the rear image 70 that serves as the effective background of the screen 22. Similar to embodiments discussed above, the processor 12 derives this area 72 based on the dimensions of the screen 22, the dimensions of the rear image 70, the field of view of the rear camera 16B, and the distance between the user and the screen 22. Unlike the previous embodiments, though, because the user's head and eyes do not remain fixed relative to the screen 22, the image processor 12 may not derive the area 72 as simply a fixed or pre-determined part of the rear image 70; indeed, the size and location of area 72 within the rear image 70 may vary depending on the user's viewing angle and/or the distance between the user and the screen 22.

Consider, for instance, FIGS. 6E-6G, which respectively illustrate a front image 100 captured by the front camera 16A, a flipped version of the front image 100A, and a rear image 80 captured by the rear camera 16B when the user instead views the screen 22 at the right angle illustrated rather than the left angle. As shown by these figures, the image processor 12 derives area 82 as being the part of the rear image 80 that serves as the effective background of the screen 22, and this area 82 is located at a different place within rear image 80 than previously discussed area 72.

Regardless of the particular location of the effective background within the rear image, though, the image processor 12 composes the digital image 24 for perceptibility as viewed against that effective background in the same way as discussed above with respect to FIGS. 3E-3H. In some embodiments, for example, the image processor 12 composes the digital image 24 from one or more logical objects that have a spatial arrangement or coloration determined in dependence on evaluation of the effective background (i.e., area 72 in FIG. 6D, or area 82 in FIG. 6G).

Of course, the image processor 12 may alternatively compose the digital image 24 for perceptibility as viewed against the effective background in other ways. The image processor 12 may for instance compose the digital image 24 to in a sense equalize the color intensities of the effective background, and thereby make the digital image 24 more perceptible. In this case, the image processor 12 composes parts of the digital image 24 that will display against low color intensities of the effective background with higher color intensities, and vice versa. Such may be done for each color component of the digital image, e.g., red, green, and blue, and for parts of the digital image 24 at any level of granularity, e.g., per pixel or otherwise.

In other embodiments, the image processor 12 composes the digital image 24 to in a sense adapt the effective background to a homogeneous color. In this case, the image processor 12 determines which color is least present in the effective background and composes the digital image 24 with colors that saturate the effective background toward that color. The image processor 12 may for instance distinguish between the background of the image 24 (e.g., the general surface against which information is displayed) and the foreground of the image 24 (e.g., the information itself), and then compose the background of the image 24 with the color least present in the effective background. The image processor 12 may also compose the foreground of the image 24 with a color that has high contrast to this background color.

Thus, those skilled in the art will again appreciate that the above descriptions merely illustrate non-limiting examples that have been used primarily for explanatory purposes. The transparent screen 22, for instance, has been explained for convenience as being rectangular, but in fact the screen 22 may be of any shape without departing from the scope of the present invention. The screen 22 may also be split into two sections, one perhaps dedicated to the left eye and the other to the right eye. In this case, the two sections may be treated independently as separate screens in certain aspects, e.g., with a dedicated evaluation of the effective background of each, but treated collectively for displaying the composed digital image 24 onto.

Moreover, depending on the particular arrangement of the front camera 16A and the rear camera 16B in those embodiments utilizing both, the image processor 12 may implement still further calibration processing to compensate for any other differences in their arrangement not explicitly discussed above.

Of course, the detector 16 for acquiring information about the environmental background (as opposed to the user's viewing angle) need not be a rear camera at all. In other embodiments, for example, this detector 16 is a chromometer (i.e., a colorimeter) or spectrometer that provides the image processor 12 with a histogram of information about the environmental background. In still other embodiments, the detector 16 is an orientation and position detector that provides the image processor 12 with information about the geographic position and directional orientation of the detector 16. This information may indirectly provide the processor 12 with information about the environmental background. Indeed, in such embodiments, the image processor 12 may be configured to determine or derive image(s) of the environmental background from image(s) previously captured at or near the geographic position indicated.

Those skilled in the art will further appreciate that the various “circuits” described may refer to a combination of analog and digital circuits, and/or one or more processors configured with software and/or firmware (e.g., stored in memory) that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

For example, in some embodiments, the image processor 12 retrieves digital image data 13 from the memory 14, which includes executable instructions for generating one or more logical objects of the digital image 24. The instructions may describe a hierarchy of logical objects in term of vector graphics (i.e., geometrical primitives) or raster graphics (i.e., pixel values). In either case, though, the instructions in at least one embodiment describe only one way to generate logical objects of the image 24; that is, the instructions in a sense define a nominal, or default, spatial arrangement and/or coloration of the logical objects that is not based on evaluation of the effective background of the screen 22. Thus, in these embodiments, the image processor 12 is configured to selectively deviate from, or even modify, the retrieved instructions in order to generate the logical Objects with a spatial arrangement and/or coloration that is indeed based on such evaluation, as described above. The particular manner in which the image processor 12 deviates from, or modifies, the instructions may be specified beforehand in pre-determined rules or dynamically on an image-by-image basis. Having deviated from and/or modified those instructions to generate the logical objects, the image processor 12 may then flatten the logical objects to form the digital image 24.

In other embodiments, though, the instructions describe several possible ways to generate logical objects of the image 24, e.g., without substantially affecting the meaning conveyed by the image 24. The instructions may, for example, describe that a button may be placed in either the lower-left corner of the image 24, or the lower-right corner of the image 24, and may be either red, green, or blue. In such embodiments, the image processor 12 is configured to assess the perceptibility of a logical object for each possible way to generate that logical object, based on evaluation of the effective background of the screen 22. The image processor 12 may then select between those possibilities in order to meet some criteria with regard to the image's perceptibility (e.g., maximum perceptibility) and generate the logical object with the selected possibility. Having generated all logical objects of the image 24 in this way, the image processor 12 may again flatten the logical objects to form the digital image 24.

Furthermore, the various embodiments presented herein have been generally described as providing for the perceptibility of a digital image 24 as viewed against the effective background. One should note, though, that the perceptibility provided for is not necessarily tailored to any particular user's perception of color. Rather, the perceptibility provided for is some pre-determined, objective perceptibility provided according to pre-determined thresholds of perceptibility and color relationships.

Those skilled in the art will also appreciate that the device 10 described herein may be any device that includes an image processor 12 configured to prepare a digital image for display on a transparent screen (whether or not the screen is integrated with or external to the device). Thus, the device 10 may be a mobile communication device, such as a cellular telephone, personal data assistant (PDA), or the like. In any event, the device may be configured in some embodiments to prepare a digital image for display on a substantially transparent screen integrated with the device itself, or on an external transparent screen communicatively coupled to the device (e.g., a heads-up display). A heads-up display as used herein includes any transparent display that presents data without requiring the user to look away from his or her usual viewpoint. This includes both head- and helmet-mounted displays that moves with the orientation of the user's head, as well as fixed displays that are attached to some frame (e.g., the frame of a vehicle or aircraft) that does not necessarily move with the orientation of the user's head.

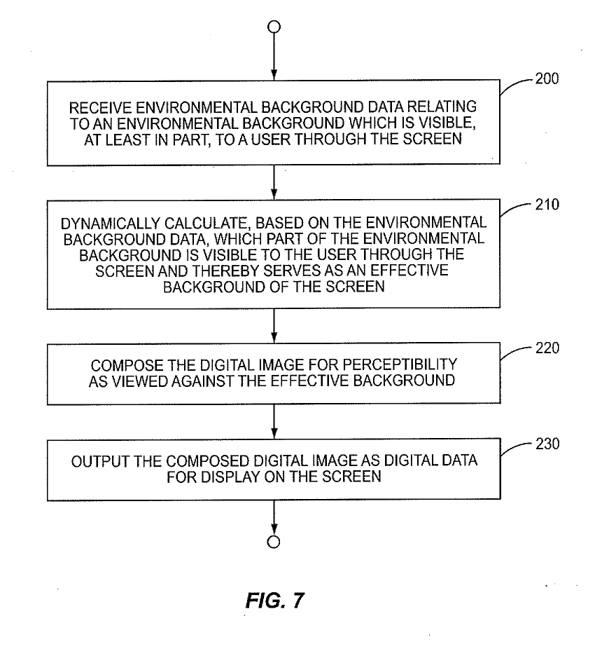

With the above variations and/or modifications in mind, those skilled in the art will appreciate that the image processor 12 described above generally performs the method shown in FIG. 7, for preparing a digital image 24 for display on a substantially transparent screen 22. In FIG. 7, the method “begins” with receiving environmental background data 15 relating to an environmental background which is visible, at least in part, to a user through the screen 22 (Block 200). The method “continues” with dynamically calculating, based on the environmental background data, which part of the environmental background is visible to the user through the screen 22 and thereby serves as an effective background of the screen 22 (Block 210). The method then entails composing the digital image 24 for perceptibility as viewed against the effective background (Block 220) and outputting the composed digital image 24 as digital data for display on the screen 22 (Block 230).

Nonetheless, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method of preparing a digital image for display on a substantially transparent screen, the method implemented by an image processor and comprising:
receiving environmental background data relating to an environmental background which is visible, at least in part, to a user through the screen;
dynamically calculating, based on the environmental background data, which part of the environmental background is visible to the user through the screen and thereby serves as an effective background of the screen;
composing the digital image for perceptibility as viewed against the effective background; and
outputting the composed digital image as digital data for display on the screen.

2. The method of claim 1, wherein receiving environmental background data comprises receiving a rear image of the environmental background and wherein said dynamically calculating comprises dynamically calculating which part of the rear image serves as the effective background of the screen.

3. The method of claim 2, wherein dynamically calculating which part of the rear image serves as the effective background of the screen comprises deriving an area around a point in the rear image as being the effective background, based on the dimensions of the screen, the dimensions of the rear image, the field of view of a rear camera capturing the rear image, and the distance between the user and the screen.

4. The method of claim 3, further comprising calibrating the center point of the rear image by displacing the center point horizontally, vertically, or both to compensate for offset of the rear camera from the center of the screen, and wherein said point in the rear image comprises the calibrated center point.

5. The method of claim 1, further comprising receiving viewing angle data relating to the viewing angle at which the user views the screen, and wherein said dynamically calculating comprises determining the viewing angle based on the viewing angle data and dynamically calculating the effective background based on that viewing angle.

6. The method of claim 5, wherein receiving viewing angle data comprises receiving a front image of the user, and wherein determining the viewing angle comprises:
detecting the location of the user's face or eyes in the front image;
calculating an angle between a vertical or horizontal axis extending from a point in the front image and a line extending between said point and said location; and
adjusting the calculated angle as needed to derive the angle that would have been calculated had the front image been flipped about said vertical or horizontal axis prior to said detection.

7. The method of claim 6, further comprising calibrating the center point of the front image by displacing the center point horizontally, vertically, or both to compensate for offset of a front camera capturing the front image from the center of the screen, and wherein said point in the front image comprises the calibrated center point.

8. The method of claim 6, wherein receiving environmental background data comprises receiving a rear image of the environmental background, and wherein said dynamically calculating comprises determining the location in the rear image that would correspond to the location of the user's face or eyes in a flipped version of the front image, as transposed across a point in the rear image at the viewing angle.

9. The method of claim 8, wherein said dynamically calculating comprises deriving an area around said location in the rear image as being the effective background, based on the dimensions of the screen, the dimensions of the rear image, the field of view of a rear camera capturing the rear image, and the distance between the user and the screen.

10. The method of claim 8, further comprising calibrating the center point of the rear image by displacing the center point horizontally, vertically, or both to compensate for offset of a rear camera capturing the rear image from the center of the screen, and wherein said point in the rear image comprises the calibrated center point.

11. The method of claim 1, wherein said composing the digital image comprises composing the image from one or more logical objects having a spatial arrangement or coloration determined in dependence on evaluation of the effective background.

12. An image processor configured to prepare a digital image for display on a substantially transparent screen, the image processor comprising:
a communications interface configured to receive environmental background data relating to an environmental background which is visible, at least in part, to a user through the screen;
an effective background calculator configured to dynamically calculate, based on the environmental background data, which part of the environmental background is visible to the user through the screen and thereby serves as an effective background of the screen; and
an image composer configured to compose the digital image for perceptibility as viewed against the effective background and to output the composed digital image as digital data for display on the screen.

13. The image processor of claim 12, wherein the communications interface is configured to receive environmental background data that comprises a rear image of the environmental background, and wherein the effective background calculator is configured to dynamically calculate which part of the rear image serves as the effective background of the screen.

14. The image processor of claim 13, wherein the effective background calculator is configured to derive an area around a point in the rear image as being the effective background, based on the dimensions of the screen, the dimensions of the rear image, the field of view of a rear camera capturing the rear image, and the distance between the user and the screen.

15. The image processor of claim 14, wherein the effective background calculator is configured to calibrate the center point of the rear image by displacing the center point horizontally, vertically, or both to compensate for offset of the rear camera from the center of the screen, and wherein said point in the rear image comprises the calibrated center point.

16. The image processor of claim 12, wherein the communications interface is configured to receive viewing angle data relating to the viewing angle at which the user views the screen, and wherein the effective background calculator is configured to determine the viewing angle based on the viewing angle data and to dynamically calculate the effective background based on that viewing angle.

17. The image processor of claim 16, wherein the communications interface is configured to receive viewing angle data that comprises a front image of the user, and wherein the effective background calculator is configured to determine the viewing angle by:
detecting the location of the user's face or eyes in the flipped front image; and
calculating an angle between a vertical or horizontal axis extending from a point in the front image and a line extending between said point and said location; and
adjusting the calculated angle as needed to derive the angle that would have been calculated had the front image been flipped about said vertical or horizontal axis prior to said detection.

18. The image processor of claim 17, wherein the effective background calculator is configured to calibrate the center point of the front image by displacing the center point horizontally, vertically, or both to compensate for offset of a front camera capturing the front image from the center of the screen, and wherein said point in the front image comprises the calibrated center point.

19. The image processor of claim 17, wherein the communications interface is configured to receive environmental background data that comprises a rear image of the environmental background, and wherein the effective background calculator is configured to dynamically calculate the effective background based on the viewing angle by determining the location in the rear image that would correspond to the location of the user's face or eyes in a flipped version of the front image, as transposed across a point in the rear image at the viewing angle.

20. The image processor of claim 19, wherein the effective background calculator is configured to derive an area around said location in the rear image as being the effective background, based on the dimensions of the screen, the dimensions of the rear image, the field of view of a rear camera capturing the rear image, and the distance between the user and the screen.

21. The image processor of claim 19, wherein the effective background calculator is configured to calibrate the center point of the rear image by displacing the center point horizontally, vertically, or both to compensate for offset of a rear camera capturing the rear image from the center of the screen, and wherein said point in the rear image comprises the calibrated center point.

22. The image processor of claim 1, wherein the image composer is configured to compose the image from one or more logical objects having a spatial arrangement or coloration determined in dependence on evaluation of the effective background.
